(19) United States
(12) Patent Application Publication
(10) Pub. No.: US 2008/0052176 A1
(43) Pub. Date: Feb. 28, 2008

(54) PAYMENT DEVICE TO ALLOW AN AUTOMATED MEANS FOR ORDERING AND PAYMENT BY FOOD ESTABLISHMENT PATRONS

(76) Inventor: BRIAN K. BUCHHEIT, DAVIE, FL (US)

Correspondence Address: PATENTS ON DEMAND, P.A., 4581 WESTON ROAD, SUITE 345, WESTON, FL, 33331, US

(21) Appl. No.: 11/467,228

(22) Filed: Aug. 25, 2006

(51) Int. Cl. G06Q 20/00

(52) U.S. Cl. 705/17

(57) ABSTRACT

A method for paying at a food establishment that begins with a patron identifying a payment point at a consumption station of a food establishment. The payment point provides the patron an invoice of purchased items. A patron can then use a payment artifact to initiate a transaction with the payment point. The transaction information can be sent to payment center associated with the payment artifact. If the payment center approves the transaction, confirmation can be sent back to the payment point. The payment point can then apply the authorized amount to the invoice of purchased items.

### BACKGROUND

1. Field of the Invention

The present invention relates to the field of electronic payment devices and, more particularly, to a payment device that allows an automated means for ordering and payment by patrons.

2. Description of the Related Art

During the peak dining hours, food establishments bustle with a constant flow of activity. The wait staff is busy seating, serving, and cashiering patrons. Since the waitstaff must juggle service to multiple tables, patrons are often left waiting to place orders and/or address payment of their bill. It can also be difficult for patrons to signal the waitstaff to address their concerns.

Additionally, the handling of electronic payments is unnecessarily drawn out. A patron must capture the attention of the waitstaff to request the bill. The waitstaff delivers the bill and often leaves to attend to other patrons. The patron must get the attention of the waitstaff yet again, in order to remit payment of the bill. Once the waitstaff collects the bill and credit card, the patron must wait for the waitstaff to return with the receipt for the patron's signature to authorize the electronic payment. Should the waitstaff be particularly busy, the time spent by the patron waiting to complete the electronic transaction can add up to a substantial amount of lost time.

Because the waitstaff must split their attention between multiple groups of patrons, the waitstaff is often seen as inattentive or lacking in service. This often results in a reduction of the patron's tip for the waitstaff. The reduction income compounded with the existing stress of handling a high volume of patrons often results in increased stress of the waitstaff and a decrease in service performance. In turn, this can detrimentally affect return business for the food establishment.

### SUMMARY OF THE INVENTION

The present invention describes an automated means for patrons of a food establishment to resolve ordering and payment transactions with minimal intervention of the waitstaff. More specifically, the food establishment provides the patron a device by which the patron interacts with to perform a variety of possible functions, including ordering and bill payment. This device can be affixed to the consumption station of the food establishment or can be carried by wait staff in a mobile form. The device can include graphical user interfaces to handle the ordering of items, the fulfillment of electronic and cash transactions, and the communication of patron requests to the waitstaff. Additionally, the device can also serve as an Internet access point, allowing patrons the capability to perform Internet actions, such as accessing email and viewing Web pages.

The present invention can be implemented in accordance with numerous aspects consistent with material presented herein. For example, one aspect of the present invention can include a method for paying at a food establishment that begins with identifying a payment point at a consumption station of a food establishment. The payment point can provide a patron an invoice of purchased items. A patron can then use a payment artifact to initiate a transaction with the payment point. The transaction information can be sent to a payment center associated with the payment artifact. If the payment center approves the transaction, confirmation can be sent back to the payment point. The payment point can then apply the authorized amount to the invoice of purchased items.

Another aspect of the present invention can include a payment method that utilizes an automated payment device. The automated payment device can be provided for patron use at the consumption stations of a food establishment.

Yet another aspect of the present invention can include an automated payment system. The system includes an input device that can be configured to be directly accessed by food establishment patrons while at a consumption station. The input device can also be configured to accept payment from patrons for purchases without the need for intervention by an agent of the food establishment.

It should be noted that various aspects of the invention can be implemented as a program for controlling computing equipment to implement the functions described herein, or a program for enabling computing equipment to perform processes corresponding to the steps disclosed herein. This program may be provided by storing the program in a magnetic disk, an optical disk, a semiconductor memory, any other recording medium, or can also be provided as a digitally encoded signal conveyed via a carrier wave. The described program can be a single program or can be implemented as multiple subprograms, each of which interact within a single computing device or interact in a distributed fashion across a network space.

The method detailed herein can also be a method performed at least in part by a service agent and/or a machine manipulated by a service agent in a response to a service request.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram illustrating a system for providing an automated payment device for patron use in accordance with embodiments of the inventive arrangements disclosed herein.

FIG. 2 is a schematic diagram of an automated payment device in accordance with an embodiment of the inventive arrangements disclosed herein.

FIG. 3 is a collection of illustrations depicting an automated payment point and graphical user interfaces (GUIs) in accordance with an embodiment of the inventive arrangements disclosed herein.

FIG. 4 is a flow chart of a method for patron use of an automated payment point in accordance with an embodiment of the inventive arrangements disclosed herein.

FIG. 5 is a flow chart of a method where a service agent can configure a system for handling automated patron payments in accordance with an embodiment of the inventive arrangements disclosed herein.

### DETAILED DESCRIPTION OF THE DRAWINGS

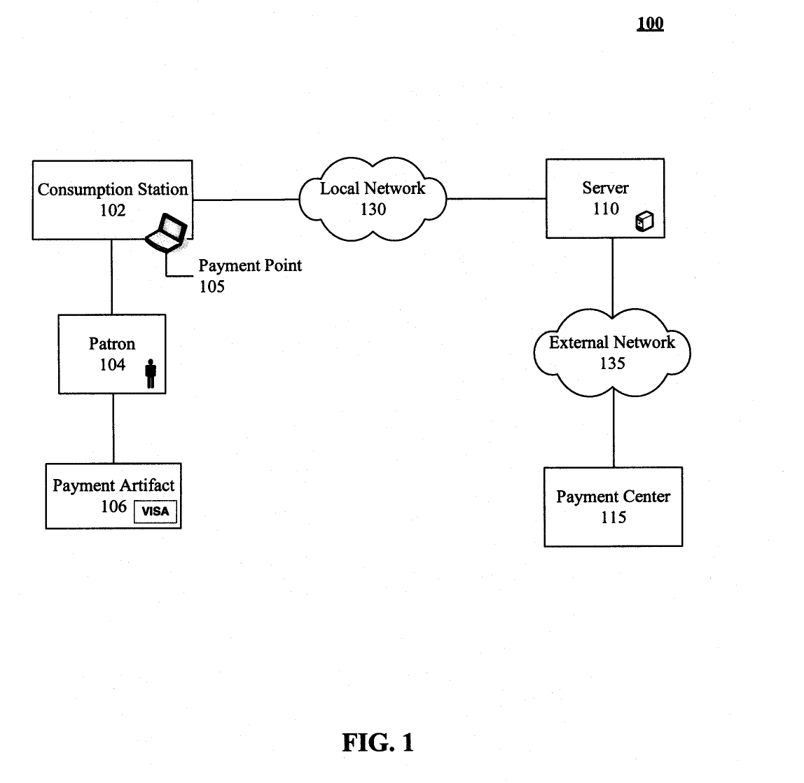

FIG. 1 is a schematic diagram illustrating a system 100 for providing an automated payment device for patron use in accordance with embodiments of the inventive arrangements disclosed herein. System 100 can include payment point 105, and payment center 115 communicatively linked through local network 130 and external network 135.

Payment point 105 can be any device that can accept and process purchase payments electronically and in an automated fashion. Payment point 105 can be any of a variety of computing devices including, but not limited to, a microcomputer, a personal data assistant (PDA), a minicomputer, a hybrid combination of computing and peripheral devices, and the like, configured to accept a variety of payment types. Payment point 105 can accept information stored upon payment artifact 106 belonging to patron 104.

Payment artifact 106 can be any device that contains encoded information representing an actual monetary amount. Payment artifact 106 can be any of a variety of encoded items including, but not limited to, a credit card, a debit card, a gift card, a smart card, a radio frequency identification (RFID) payment device, and Internet payment account (e.g., PAYPAL), and the like. It should be appreciated that the types of acceptable payment artifacts are limited to those whose information can be read and transmitted by the components of payment point 105.

Payment point 105 can be permanently affixed to consumption station 102. In another contemplated embodiment, payment point 105 can be implemented in a form that allows mobility and service to multiple consumption stations. Connectivity to local network 130 by payment point 105 can be achieved in a variety of means including, but not limited to, a wireless transceiver embedded within payment point 105, a network access port contained within or upon consumption station 102, a cable from a network access port, and the like.

Server 110 can be any type of network server that can support the activities of payment point 105 and communications with payment center 115. Server 110 communicates with payment point 105 via local network 130 and with payment center 115 via external network 135.

Payment center 115 can be an entity associated with payment artifact 106 for the purposes of authorizing purchase transactions. For example, the payment center 115 can be a bank, a credit card center, a gift card redemption server, and the like. Payment center 115 can be implemented in a variety of means including, but not limited to a Web service, an automated data transaction, a phone service, and the like.

Interaction among the components of system 100 can be clarified through an example as follows. It should be appreciated that the following example is for illustrative purposes only and that the invention should not be construed as limited to the specific arrangements used within. In the example, patron 104 is attempting to pay for items purchased at consumption station 102 via payment point 105. To do so, patron 104 transfers the information contained on payment artifact 106 to payment point 105 to authorize the purchase, such as by swiping the magnetic strip of a credit card through a magnetic strip reader.

Payment point 105 then sends the information received from payment artifact 106 to payment center 115 via local network 130, server 110, and external network 135. Payment center 115 sends its response for authorization back to payment point 105 through the reverse route. Payment point 105 applies the authorized payment to the bill of patron 104, completing the transaction.

Local network 130 and external network 135 can include any hardware/software/and firmware necessary to convey data encoded within carrier waves. Data can be contained within analog or digital signals and conveyed though data or voice channels. Local network 130 and external network 135 can include local components and data pathways necessary for communications to be exchanged among computing device components and between integrated device components and peripheral devices. Local network 130 and external network 135 can also include network equipment, such as routers, data lines, hubs, and intermediary servers which together form a data network, such as the Internet. Local network 130 and external network 135 can also include circuit-based communication components and mobile communication components, such as telephony switches, modems, cellular communication towers, and the like. Network 130 and network 135 can include line based and/or wireless communication pathways.

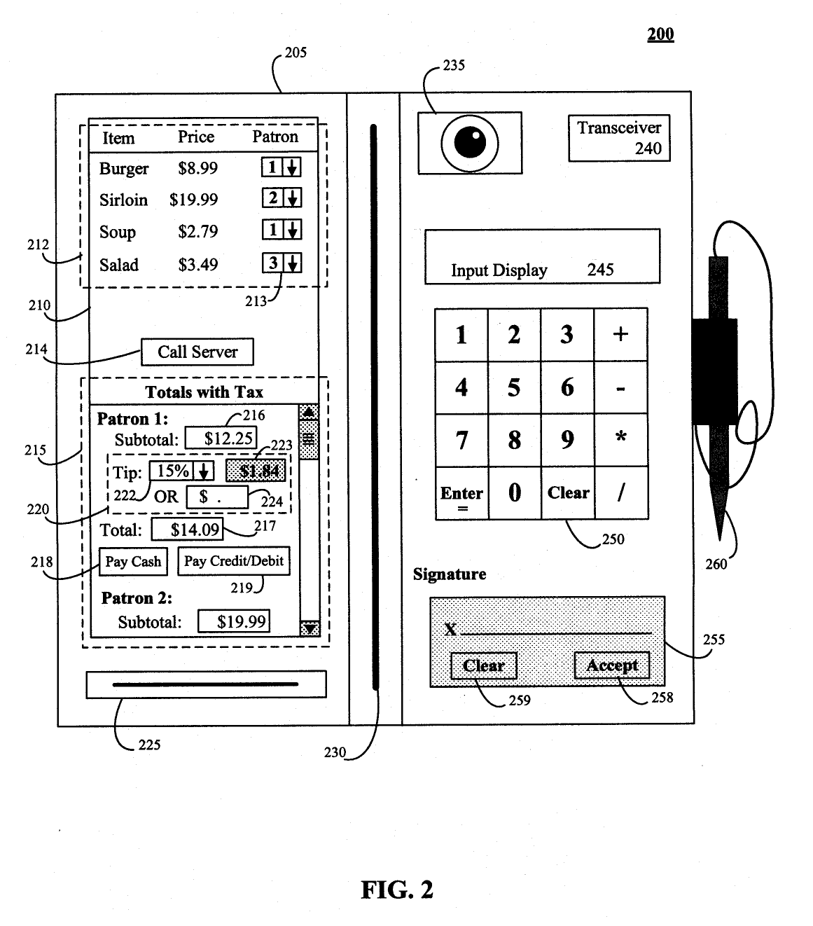

FIG. 2 is a schematic diagram 200 of an automated payment device in accordance with an embodiment of the inventive arrangements disclosed herein. The device of schematic 200 can be performed in the context of system 100 or any other system supporting automated patron payments.

Payment device 205 can include touch screen 210, receipt printer 225, information reader 230, image capture device 235, transceiver 240, input display 245, input pad 250, signature block 255, and writing tool 260. Payment device 205 can be constructed in a form suitable for mobility or for housing within a structure that is permanently affixed to specified location.

Touch screen 210 can include invoice display 212, call button 214, and payment area 215. Invoice display 212 can present a visual list of items purchased by the patron or a group of patrons. Invoice display 212 can also include the means for grouping items to express payment by a specific patron or splitting the check, such as by patron selector 213. Patron selector 213 can be implemented in a variety of manners including, but not limited to a drop-down list, a pop-up window, a text-input area, and the like, such that a specific designation can be assigned to a specific purchased item in order to designate the separation of items for billing and payment. The inclusion of multiple patrons for payment can then be reflected in the contents of payment area 215.

Call button 214 can represent a means for a patron to indicate their need for service by waitstaff. In order to alert waitstaff for service, call button 214 can utilize transceiver 240 to send a signal to a receiver in the possession of waitstaff. Alternately, call button 214 can produce an indicator in the software running on the computing devices used by waitstaff. For example, use of call button 214 could result in a text message containing the table number of the requesting party being sent to a waitstaff's pager.

Payment area 215 can be an interface by which a patron or group of patrons indicate their respective payment methods. Payment area 215 can include subtotal 216, tip designator 220, total display 217, cash payment button 218, and electronic payment button 219. As shown in this example, payment area 215 displays payment information for multiple patrons, as designated in the invoice display. For the sake of brevity, the components for a single patron will be discussed herein, since these components would simply be repeated for each designated patron.

Subtotal 216 can contain the monetary subtotal for the items purchased by a patron. Subtotal 216 can be configured to include calculated taxes for the calculated subtotal. Tip designator 220 can contain the means for a patron to specify a monetary tip for the waitstaff. Tip designator can include percentage indicator 222, percentage display 223, and amount designator 224. Percentage indicator 222 can be a means to select a preset percentage value to use by payment point 205 to calculate a tip amount. As shown in this example, a selected value of 15% results in the calculation of $1.84 for a tip, shown in percentage display 223. Instead of selecting a percentage value, a patron could elect to specify an amount in amount designator 224.

The sum of subtotal 216 and tip designator 220 can be presented in total display 217. This value represents the monetary amount expected by the food establishment as payment from the patron for the purchased items. A patron can then press either cash payment button 218 or electronic payment button 219 to indicate their intended payment method.

Cash payment button 218 can represent a patron's intention to use some form of note or coin currency as payment for the purchased items. The representation of payment device 205 shown in illustration 200 would alert waitstaff of the patron's desire to conduct a cash transaction, effectively functioning similarly to call button 214. In a contemplated embodiment, payment device 205 can include an additional component (not shown) expressly for handling cash payments, accepting currency for payment and, then, dispensing the calculated change.

Electronic payment button 219 can represent a patron's intention to use an electronic means, such as payment artifact 106 of system 100, to provide payment for the purchased items. Selection of electronic payment button 219 can require the additional use of information reader 230, keypad 250, and signature block 255.

Receipt printer 225 can be a type of printer capable of producing a receipt of the payment transaction conducted by payment point 205. Receipt printer 225 can print a receipt upon completion of an electronic payment transaction. In the alternative embodiment containing cash handling capabilities, receipt printer 225 would also issue a receipt upon the completion of a cash payment transaction.

Information reader 230 can be used to access encoded information on a patron's payment artifact. Information reader 230 can be implemented in a variety of manners including, but not limited to a magnetic strip reader, a bar code reader, a smart card reader, a RFID antenna, and the like. It should be appreciated that the type of payment artifacts accepted by payment device 205 can be limited by the implementation of information reader 230. For example, in the above illustration, information reader 230 is a magnetic strip reader, and, therefore, would only accept payment artifacts whose information is encoded in magnetic strips, such as credit or debit cards.

Image capture device 235 can be a means to verify patron identity by taking a picture of the patron performing the payment transaction. Image capture device 235 can be implemented in a variety of means including, but not limited to, a web camera, a digital camera, and the like.

Transceiver 240 can represent the means by which payment device 205 connects to local network 130 and, subsequently, payment center 115 of system 100. Transceiver 240 can be implemented with a variety of devices including, but not limited to, a wireless network transceiver, a radio-frequency transceiver, a universal serial bus (USB) port, a set of different transceiver types, and the like.

Input display 245 can display a variety of characters and words relating to input pad 250. Input display 245 can be a variety of display types including, but not limited to a light-emitting diode (LED) display, a liquid crystal display (LCD), a segment display, and the like. Input display 245 can display instructions for using input pad 250 as well as the characters corresponding to buttons of input pad 250 that are pressed by patrons.

Input pad 250 can be used by a patron to enter characters into payment device 205. Input pad 250 can include a variety of input mechanisms including, but not limited to a numeric keypad, and alphanumeric keypad, a touch screen display of a keypad, a keyboard, and the like. It should be appreciated that the functionality of payment device 205 can be limited by input pad 250. For example, in the above illustration, input pad 250 is a numeric keypad with a calculator configuration, and therefore, would support calculator functions in payment device 205.

Signature block 255 can be used by a patron to provide a digital signature for an electronic transaction. Signature block 255 can be implemented in a variety of manners including, but not limited to a touch screen, a computer video display with a light pen, an area to sign a paper receipt with a conventional writing implement, and the like. It should be appreciated that the subordinate components of signature block 255 can vary, depending on the implementation used. In the above illustration, signature block 255 is a touch screen implementation, containing accept button 258 and clear button 259. Selection of accept button 258 by a patron causes payment device 205 to receive the digital signature, whereas clear button 259 clears signature block 255 of input.

Writing tool 260 can be used to perform actions on touch screen 210 or any other touch screen component of payment device 205. Writing tool 260 can be any variety of instruments including, but not limited to a stylus, an ink pen, a pencil, and the like. It should be noted that the implementation of signature block 255 can influence the choice of implementation or writing too 260. For example, a touch screen signature block requires the use of a stylus; and ink pen or pencil will not function properly under such conditions.

It should be appreciated that the various components of diagram 200 are presented for illustrative purposes and derivatives and alternative implements are contemplated. These alternatives can utilize different technologies and/or devices to perform the functions detailed herein. For example, instead of a touch screen 210, device 205 can utilize a normal screen, which has selectable buttons (not shown) beside displayed options. The signature block 255 can be substituted with a biometric reader, such as a fingerprint reader or retinal scanner, which can be used for identification purposes. The payment area 215 can include a clip (not shown) instead of a digital display area, where printed totals can be clipped to inform patrons of amounts due.

Additionally, mechanisms shown as integrated to device 205, such as image capture device 235 can be implemented with an external device, such as a video camera established for an eating establishment. Further, other mechanisms, such as transceiver 240, can be replaced by alternate components that are used to integrate device 205, with an external system, which can perform the transceiving function. For example, a flash memory (not shown) can be included in the device 205, where the flash memory can store input. When device 205 is docked to a fixed system, the input stored in the flash memory can be automatically transferred to the fixed system. The fixed system can include a network connection (transceiver 240) to a remotely located payment center.

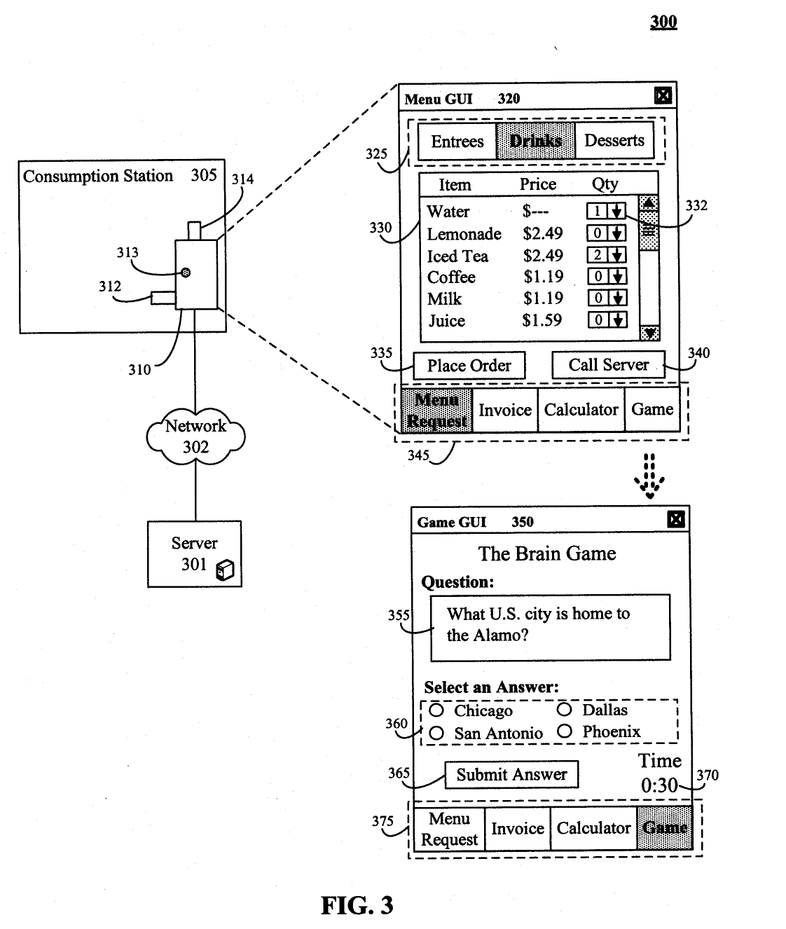

FIG. 3 is a collection 300 of illustrations depicting an automated payment point and graphical user interfaces (GUIs) in accordance with an embodiment of the inventive arrangements disclosed herein. The illustrations of collection 300 can be performed in the context of system 100 or any other system supporting automated patron payments.

Consumption station 305 can be an area of a food establishment where patrons can purchase and consume items. Consumption station can contain payment point 310 that is communicatively linked to server 301 via network 302. In this embodiment, payment point 310 is affixed to consumption station 305 and can house payment device 205 of system 200. Payment point 310 can contain cash handling component 312, sound capture device 313, and transceiver 314.

Cash handling component 312 can accept currency for payment and dispense the proper amount of currency calculated as change. Cash handling component 312 can be any of a variety of currency accepting and dispensing devices including, but not limited to, a cassette cash dispenser, a coin hopper, a coin slot, a bill acceptor, and the like.

Sound capture device 313 can receive audio input from patrons using payment point 310. Sound capture 313 can be any of a variety of audio devices including, but not limited to, a microphone, a two-way radio, a speech recognition component, and the like.

Similar to transceiver 240 of system 200, transceiver 314 can represent the means by which payment point 310 connects to network 302 and server 301. Transceiver 314 can be implemented with a variety of devices including, but not limited to, a wireless network transceiver, a radio-frequency transceiver, a universal serial bus (USB) port, a set of different transceiver types, and the like.

Payment point 310 can include a variety of user interfaces, such as Menu GUI 320, which could be displayed in touch screen 210 of payment device 205 of system 200. Menu GUI 320 can allow patrons to select items for purchase. Menu GUI 320 can be implemented in a variety of manners including, but not limited to, a stand-alone software application, an applet, a thin client, a client application, a Web application, and the like. Menu GUI 320 can include menu buttons 325, selection area 330, order button 335, call button 340, and function buttons 345.

Menu buttons 325 can be selected to change the list of items available for purchase. Selection of one of the buttons contained in menu buttons 325, illustrated as shaded, displays the associated list of items for purchase in selection area 330. Selection area 330 can display a list of items available for patron purchase. In addition to display item names, selection area 330 can include a means for patrons to specify a quantity of items to purchase, as shown by quantity selector 332. Quantity selector 332 can be implemented in a variety of manners including, but not limited to a drop-down list, a pop-up window, a text-input area, and the like.

Order button 335 can transmit patron item selections to a designated receiving station for fulfillment. Transmission of this data can be achieved using transceiver 314.

Call button 340 can represent a means for a patron to indicate their need for service by waitstaff. In order to alert waitstaff for service, call button 340 can utilize transceiver 314 to send a signal to a receiver in the possession of waitstaff. Alternately, call button 340 can produce an indicator in the software running on the computing devices used by waitstaff. For example, use of call button 340 could result in a text message containing the table number of the requesting party being sent to a waitstaff's pager.

Function buttons 345 can change the content and functionality of the interface. Selection of one of the buttons contained in function buttons 345, illustrated as shaded, displays the associated GUI. As shown in menu GUI 320, function buttons 345 show the button for menu ordering as selected. Should a patron select another member of function buttons 345, such as the one designated as “Game”, menu GUI 320 would be replaced with game GUI 350.

Game GUI 350 can be implemented in a variety of manners including, but not limited to, a stand-alone software application, an applet, a thin client, a client application, a Web application, and the like. Game GUI 350 can contain any components necessary for the functioning of the designated game. In this example, game GUI 350 represents an interface for an interactive trivia game: its description is reflective of its purpose and is not as limit of the invention.

Game GUI 350 can include question area 355, answer area 360, answer button 365, timer 370, and function buttons 375. Question area 355 can display the trivia question that is currently active and available for a patron to submit an answer. Answer area 360 can represent the means by which a patron selects an answer for the question displayed in question area 355. Answer area 365 can be implemented in a variety of manners including, but not limited to, a text entry block, a drop-down list, a set of radio buttons, a set of checkboxes, and the like.

Answer button 365 can transmit a patron's answer to the trivia question to the component conducting the game. Transmission of this data can be achieved using transceiver 314. Timer 370 can represent the time allotted for patrons to submit an answer to the current trivia question.

Function buttons 375 of game GUI 350 operate in the same manner as function buttons 345 of menu GUI 320. In game GUI 350, function buttons 375 shows the button for game playing as selected.

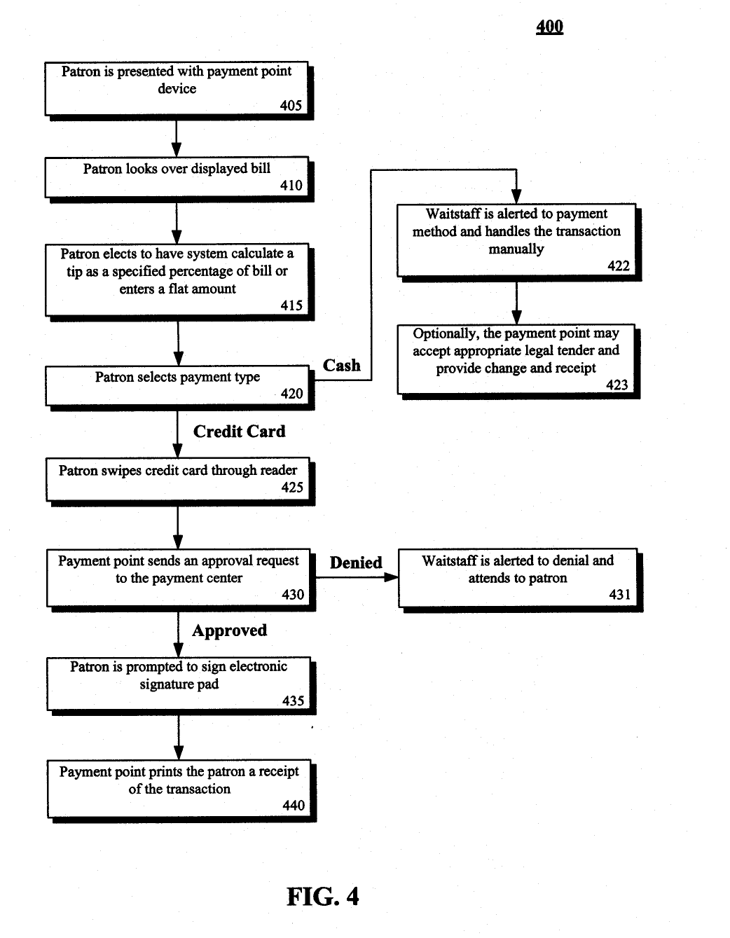

FIG. 4 is a flow chart of a method 400 for patron use of an automated payment point in accordance with an embodiment of the inventive arrangements disclosed herein. Method 400 can be performed in the context of systems 100, 200, 200, or in the context of any other system supporting automated patron payments.

Method 400 can begin in step 405, where a patron is presented with a device to conduct an automated payment. In step 410, the patron can examine an invoice presented within the payment point.

The patron can add a tip amount to the invoice, either calculated by the system or manually entered, in step 415. Step 420 represents a patron's choice of payment type. The selection of a cash payment diverts flow to step 422, where waitstaff can be signaled to handle the transaction manually. Optionally, step 423 can occur if the payment point is configured to accept and dispense currency for cash transactions.

Should the patron elect to perform a credit card or other form of electronic transaction, step 425 can be executed, where the patron swipes the credit card through the magnetic strip reader. Next, the payment point can request approval for the transaction to the payment center associated with the credit card in step 430. If the approval request results in a denial, step 431 can be executed, where waitstaff can be alerted to the issue and can attend to the patron.

Approval of the electronic transaction executes step 435, where the patron can be prompted to provide an electronic signature. Upon acceptance of the signature, the payment point can print the patron a receipt of the transaction in step 440.

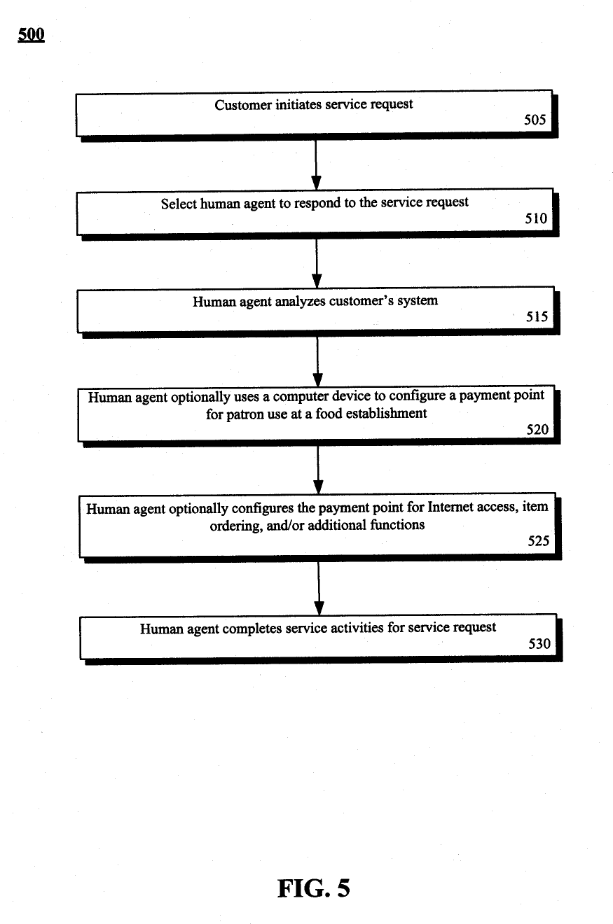

FIG. 5 is a flow chart of a method 500 where a service agent can configure a system for handling automated patron payments in accordance with an embodiment of the inventive arrangements, disclosed herein. Method 500 can be performed in the context of systems 100, 200, 300, and/or method 400.

Method 500 can being in step 505, when a customer initiates a service request. The service request can be a request for a service agent to establish a new system for handling automated patron payments. The service request can also be a request to troubleshoot a problem with an existing automated patron payment system or to enhance an existing automated patron payment system.

In step 510, a human agent can be selected to respond to the service request. In step 515, the human agents can analyze a customer's current system and can develop a solution. The solution can result in a system 100, a system 200, a system 300, or in the context of any other system supporting automated patron payments, such as a system that performs the steps of method 400.

In step 520, the human agent can configure the customer's system to include an automated payment point for patron use. In step 525, the human agent can optionally configure the payment point to include Internet access, item ordering, and/or any other customer-requested functions. For example, the service agent can load and configure software and hardware so that client devices will automatically communicate ordering information to stations where food preparation is performed. In step 530, the human agent can complete the service activities.

The present invention may be realized in hardware, software, or a combination of hardware and software. The present invention may be realized in a centralized fashion in one computer system, or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

What is claimed is:

1. A method for paying at a food establishment comprising:
identifying a payment point accessible by at least one patron from a consumption station of a food establishment;
providing an invoice of purchased items to the patron while the patron is located at the consumption station;
using the payment point to automatically initiate a patron authorized transaction using a payment artifact of the patron;
responsive to the initiated transaction, automatically conveying payment information including a payment amount from the payment point to a payment center, wherein the payment center is associated with the payment artifact;
the payment point receiving from the payment center a confirmation of the amount; and
automatically applying the amount to the invoice.

2. The method of claim 1, wherein the payment point includes a magnetic strip reader, and wherein the payment artifact comprises at least one of a credit card and a debit card.

3. The method of claim 1, wherein that at least one patron comprises a plurality of patrons, each with a corresponding payment artifact, wherein the applying step occurs for amounts associated with each of the payment artifacts provided by the plurality of patrons, whereby a food establishment bill is able to be split into multiple portions paid by different patrons using patron-specific payment artifacts.

4. The method of claim 1, wherein the payment point is a fixed automated payment device associated with the consumption station.

5. The method of claim 1, wherein the payment point is a mobile device provided to different patrons located at different consumption stations.

6. The method of claim 1, wherein the invoice is electronically presented within a display screen of the payment point.

7. The method of claim 6, wherein subsequent to the applying step, the displayed invoice is automatically updated to reflect the applied amount.

8. The method of claim 1, wherein the patron authorized comprises:
receiving digitally encoded information from the payment artifact; and
receiving patron provided authorization data, wherein both the digitally encoded information and the authorization data are required by the payment center in order for the payment center to disperse funds.

9. The method of claim 1, wherein said steps of claim 1 are performed by at least one machine in accordance with at least one computer program having a plurality of code sections that are executable by the at least one machine.

10. A payment method comprising:
providing an automated payment device to consumption stations of food establishments for patron use.

11. The payment method of claim 10, wherein the payment device is a computing device including a magnetic strip reader and a transceiver, said method further comprising:
receiving digital information from a payment artifact via the magnetic strip reader,
conveying the digital information via the transceiver to a payment center associated with the payment artifact, wherein the food establishment are paid by the payment center for patron purchased items; and
providing a result of payment transaction from the payment center via the transceiver.

12. The payment method of claim 10, wherein the payment device includes a transceiver and an Internet interface, said method further comprising:
connecting a patron to an Internet payment account via the Internet interface;
conveying digital information via the transceiver to a payment center, wherein the digital information contains patron authorizing data for purchasing items using the Internet payment account, wherein the food establishments are paid by the payment center for patron purchased items; and
providing a result of a payment transaction from the payment center via the Internet interface.

13. The payment method of claim 10, wherein the payment device comprises a display, said method further comprises:
presenting an invoice for purchased items upon the display; and
after a payment transaction conducted via the payment device, automatically updating the presented invoice to reflect results of the payment transaction.

14. The payment method of claim 10, wherein the payment device comprises an automated ordering interface, said method further comprising:
receiving an order for an item via the ordering interface from a patron;
automatically conveying the order to an agent of the food establishment to enable the agent to prepare the ordered item;
automatically adding a cost for the ordered item to an invoice;
presenting the invoice for purchased items to the patron; and
receiving payment for the presented invoice via the automated payment device.

15. The payment method of claim 10, wherein the payment device includes an Internet interface, said method further comprising:
permitting patron at the consumption stations to utilize the Internet interface to perform an Internet action, wherein the Internet action comprises at least one of accessing email messages and browsing Web pages.

16. The payment method of claim 10, wherein the automated payment device is a mobile device situationally provided to different consumption stations.

17. An automated payment system comprising:
an input device configured to be directly accessed by patrons while each of the patrons is located at a consumption station, wherein the input device is configured to receive payment from each of the patrons for purchases, whereby patrons are able to utilize the input device to pay without agent assistance.

18. The payment system of claim 17, wherein the input device comprises a magnetic strip reader configured to obtain digital information encoded with payment artifacts, wherein payment artifacts accepted by the magnetic strip reader comprise at least one of a credit card and a debit card and wherein the system further comprises a transceiver configured to automatically convey the digital information obtained from the magnetic strip reader to a payment center associated with the payment artifacts.

19. The payment system of claim 17 wherein the input device is a mobile device configured to be situationally presented to patrons at different consumption stations, and wherein the transceiver is a wireless transceiver.

20. The payment system of claim 17, further comprising:
a graphical user interface configured to present information to the patrons, wherein said invoice includes an itemized listing of all purchased items and a total owed for the purchased items; and
an invoice splitter configured to permit patrons to separately and automatically pay for different items on the invoice using the input device.
